(19) United States
(12) Patent Application Publication
(10) Pub. No.: US 2002/0020738 A1
(43) Pub. Date: Feb. 21, 2002

(54) Method and apparatus for performing value transactions

(76) Inventors: Bernard Joseph Campbell, Hampshire (GB); Peter James Waine, Chobham (GB)

Correspondence Address: Fish & Richardson P.C., 45 Rockefeller Plaza, Suite 2800, New York, NY, 10111, US

(21) Appl. No.: 09/912,678

(22) Filed: Jul. 25, 2001

(30) Foreign Application Priority Data
Aug. 7, 2000 (EP) 00306695.8

(51) Int. Cl. G06F 17/60

(52) U.S. Cl. 235/379; 705/39

(57) ABSTRACT

A transaction system comprises a LAN incorporating a plurality of transaction units and a server. The server can cause the transaction units to perform operations, such as revaluations, on respective, predetermined smart cards inserted into the transaction units in response to instructions received externally, for example via the internet. The unit server stores a database, accessible via the internet, including the credit values stored by the data-carrying devices. The information is reconciled each time a device is inserted in the transaction unit. Revaluation can take place in a progressive, timed manner.

This invention relates to methods and apparatus for performing value transactions.

Conventional vending machines dispense products or perform services in exchange for cash deposited in the machine. Some machines can be operated by portable data-carrying devices, such as smart cards, which contain a credit value forming “electronic cash”. Smart cards storing electronic cash can also be used to pay for goods at attended tills and the like. The stored electronic cash is decremented in accordance with the value of the purchased products or service, and can be replenished using a revaluation terminal. Normally, the user has to insert cash into the revaluation terminal, but it is known also to provide a system whereby the payment for the electronic cash is deducted directly from the wages of the user. This latter system would normally be a closed site system in which the revaluation terminals and vending machines are accessible only to employees of a certain organisation.

It would be desirable to provide a more versatile and convenient system for enabling transactions.

Aspects of the present invention are set out in the accompanying claims. Various independent aspects are combined in a preferred embodiment of the invention, to be described below, which provides for controlled and flexible revaluation of data-carrying devices, comprehensive collection of transaction information and flexibility of operation enabling increased functionality.

The present invention is primarily, although not exclusively, concerned with closed site systems incorporating a number of transaction devices such as attended points of sale, vending machines and/or revaluation terminals, at least some, but not necessarily all, of the transaction devices being capable of communication with a server (for example being connected in a Local Area Network).

According to one aspect of the invention, the server is operable to receive instructions relating to an individual portable data-carrying device and in response thereto to cause predetermined operations to be performed automatically by any one of a plurality of transaction units in response to that transaction unit reading that data-carrying device.

This technique could be used for revaluation (i.e. adding credit to the data-carrying device). When a revaluation transaction unit receives an appropriate data-carrying device, the stored credit value is increased in accordance with a chosen revaluation amount, and a confirmation message is sent by the revaluation unit to the server. The server then performs a cancelling operation, so that the instructions are not carried out repeatedly.

In this way, a revaluation process can be instructed centrally, without restricting the actual revaluation operation to a specified terminal, and preferably without requiring any special operation on the part of the cardholder. This technique is particularly useful in the preferred embodiment of the invention in which the server receives revaluation instructions from a Wide Area Network, such as the internet.

In accordance with a further aspect of the invention, the server is operable to send to the transaction units messages which include identifiers for data-carrying devices. When a matching data-carrying device is received by a transaction unit, the unit is operable to perform any selected one of a number of different types of operations under the control of the server. This operation could be defined by the original message sent to the transaction devices, or could be defined by a further communication between the server and an individual transaction unit which takes place in response to receipt of a matching data-carrying device. Once the operation has been performed, the server can send cancelling messages to the other transaction units.

This aspect of the invention can be used for a variety of purposes, including revaluation of cards, issuing of free prizes, discounts, “blacklisting” of cards, etc.

In accordance with another aspect of the invention, the server collects transaction data relating to the transactions carried out using respective data-carrying devices. The transaction information includes the current credit values stored on the data-carrying devices. However, there are preferably provisions to allow for the fact that there may be transaction devices which are not part of the LAN, so that the server is unable to collect information relating to transactions performed by those units. Accordingly, the server is preferably operable to correct credit data in response to a transaction unit reading a different amount from a data-carrying device, which will occur if the data-carrying device has previously been used in a stand-alone transaction unit.

In accordance with a preferred aspect, the server is operable also to store revaluation data in respect of each data-carrying device, this representing an amount by which the credit value on the device should be increased. This is stored separately from the record of the current credit amount, which, as indicated above, may be inaccurate. When a data-carrying device is inserted into a transaction unit on the LAN, the revaluation amount can be added to the value stored on the device and the credit value stored on the server could be updated to take into account both any inaccuracies and the increased value resulting from the addition of the revaluation amount.

According to a further preferred aspect of the invention, the server is operable to authorise the transfer of a revaluation amount to a data-carrying device in progressive stages. This places a limit on the average rate at which the value on the data-carrying device can be spent, which may be particularly useful for some situations (for example when the transaction system is installed in a school and used by pupils, and where parents wish to have greater control over their children's spending behaviour).

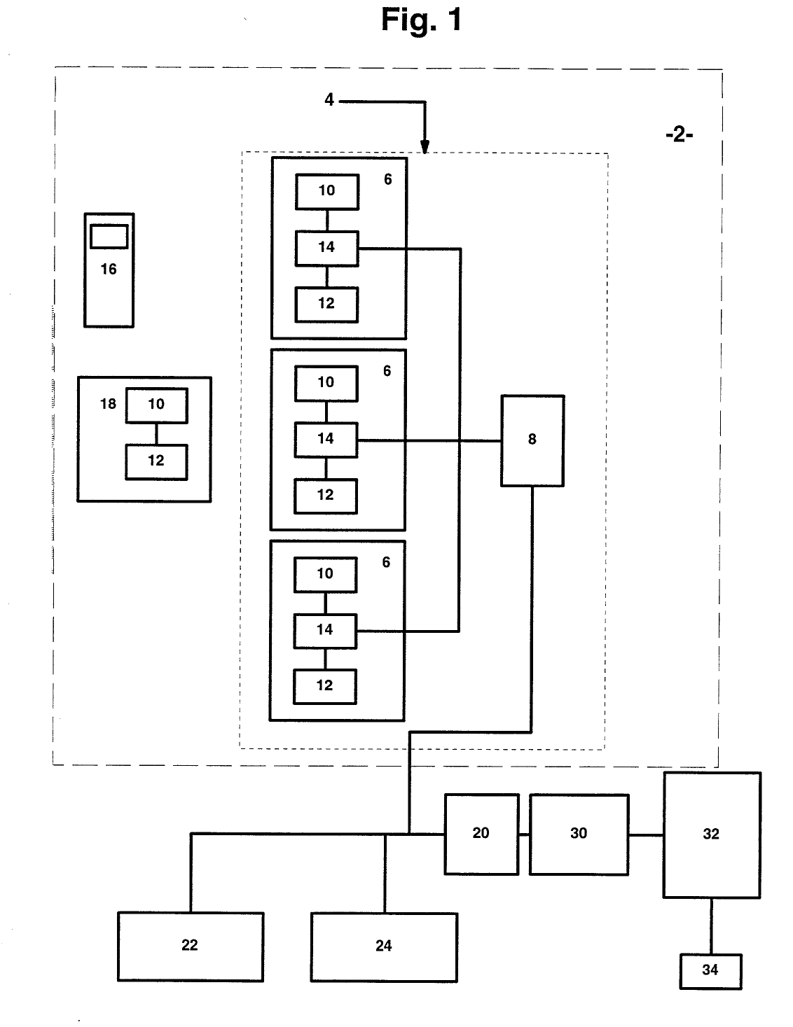

An arrangement embodying the invention will now be described by way of example with reference to the accompanying drawing, FIG. 1, which schematically shows a transaction system in accordance with the present invention.

The transaction system 2 comprises a LAN 4 incorporating a plurality of transaction units 6 connected via a standard network arrangement to a unit server 8. Each transaction unit 6 houses a purchasing unit 10, a card reader 12 and a point-of-sale (POS) LAN module 14. The purchasing unit 10 is operable to permit or record purchases, and may be a vending machine, or a cafeteria till into which purchase details are entered manually or by using machine-reading techniques. The card reader 12 is operable to read and write data stored by data-carrying devices, in the form of smart cards, one of which is shown schematically at 16. Information collected from the purchasing unit 10 and the card reader 12 can be conveyed to the server 8 via the module 14.

In this embodiment, the transaction units 6 are capable of use both for purchasing and revaluation of credit data stored by the data-carrying devices. As an alternative, these functions could be carried out by separate units.

The transaction system 2 also has one or more additional stand-alone transaction units 18, which are not connected to the LAN 4, but which additionally have purchasing units 10 and card readers 12.

Purchasing units 10 in the form of vending machines may additionally be capable of accepting cash, instead of requiring the use of a smart card.

The server 8 in this embodiment is connected to a data centre 20 which handles data from this transaction system 2 and other transaction systems such as those shown schematically at 22 and 24. It is envisaged that each transaction system 2, 22, 24, etc. would be associated with a respective specific customer of a transaction system operator, and possibly with a specific geographical site. The data centre 20 would be associated with the operator.

The data centre 20 is connected to a web server 30 which is operable to communicate with a wide area network schematically illustrated at 32, and preferably formed by the internet. This permits individuals (such as schematically illustrated at 34) with PC access to the internet to transfer data to and from the web server 30.

There are a number of user accounts associated with the transaction system 2, each user account being associated with an identifier stored on a respective data-carrying device 16 which is provided for the account holder. For each account, the unit server 8 stores a record including the following data:

1. the card identifier;

2. the current credit amount;

3. revaluation data;

4. the details (including purchased product codes and prices) of the last 10 transactions associated with the account; and

5. activity data, discussed further below.

The same data is stored (together with the relevant data for other transaction systems 22, 24) in the data centre 20 and the web server 30. Data exchange between the unit server 8, data centre 20 and web server 30 occurs regularly, so that any changes made to the data in any of the units are propagated to the other units.

Assuming that the transaction system operator has provided to each account holder (a) a data-carrying device storing an identifier representing the account, (b)) a personal identification number (PIN) enabling use of the data-carrying device and (c) an account code (which may correspond to the identifier stored by the data-carrying device and and/or a number printed on the device), then the system operates as follows.

An account holder can arrange to add or increase the value of credit on an associated data-carrying device 16. This can be achieved without requiring the account holder to have the device in his possession. This is particularly suitable therefore for situations in which the payment is made by an individual who is not necessarily the person that uses the device. For example, if the transaction system is for the use of pupils in schools, the payments can be made by parents without requiring the devices carried by the pupils.

The payments can be made in a number of ways. The parent may post a cheque to the transaction system operator, as a result of which a revaluation amount, corresponding to the value of the cheque, will be entered against the relevant account details stored in the data centre 20. Alternatively, payment could be made by sending appropriate credit card details from a terminal 34 to the web server 30 via the internet 32. Other systems which are known in themselves for effecting payments via the internet could be used, for example transferring instructions to a third party organisation which then arranges for an e-mail to be sent to the intended recipient of the payment (in this case the transaction system operator) and for value to be taken from the account of the parent and placed in the account of the third party, and the corresponding amount to be taken from the account of the third party and placed in an account associated with the transaction system operator.

As a result of this operation, a revaluation amount is stored in either the data centre 20 or the web server 30. After the next regular exchange of data, this revaluation amount is stored in the unit server 8, the data centre 20 and the web server 30.

The transaction system operator is able to enter into the data centre 20 an identifier representing a particular data-carrying device, for the purpose of “blacklisting” the device, i.e. rendering it inoperable, for example if the operator is notified that the device has been lost or stolen. This information is also distributed to the unit server 8 and the web server 30.

The data centre 20 is also arranged to perform operations which may result in instructions relating to individual accounts. For example, there could be an operation to select an account at random and then store, in association with the selected account, data representing that a free prize is to be awarded to the associated card holder. Alternatively, or additionally, the data centre may be arranged to take into account the number and/or nature of transactions which have been performed in relation to a particular account to determine whether free prizes and/or discounts should be granted to the cardholder. The results of any such operations are stored by the data centre and, following information exchange, by the unit server 8 and the web server 30.

For each account, the unit server stores activity data, which comprises an “activity flag” and an “activity description”. The activity flag is set whenever the unit server detects that an operation is required to be performed by a transaction unit in respect of a particular account. The activity description is set to represent the details of the operation or operations to be carried out in respect of each account for which the activity flag is set.

The activity flag stored by the unit server 8 would thus be set in the event that any of the above-mentioned operations (for example blacklisting, revaluation, awarding of free prizes, etc.) is required to be carried out in respect of a particular data-carrying device. The state of the flags is examined following information exchange, and the unit server 8 is arranged to send to each of the transaction units 6 a list of all identifiers associated with set activity flags.

A cardholder can make purchases at a transaction unit 6 by inserting his data-carrying device into the card reader 12. The operation may be arranged to be enabled only if the cardholder then inserts the correct PIN into a keyboard. This step may be dispensed with, particularly if the purchasing units 10 are attended tills. The value of any purchases made using the purchasing unit 10 is deducted from the credit amount stored on the data-carrying device. Following the transaction, details of the transaction including the product code and prices and the card identifier are transmitted to the unit server 8, together with the updated credit amount now stored by the device 16.

If, on the other hand, the transaction unit 6 finds a match between the identifier of the data-carrying device 16 and one of the identifiers associated with a set activity flag and received from the unit server 8, then the transaction unit 6 is arranged to send a message to the unit server 8 to indicate that this match has been found. The unit server 8 then sends to the relevant transaction unit 6 an instruction which identifies the operation to be performed, as defined by the activity description. As a result, a revaluation amount may be added to the credit amount stored on the data-carrying device 16, or an alert device (not shown) on the transaction unit 6 may be operated to indicate (using an audio and/or visual transducer) that a free prize is to be awarded. Other operations may include the transfer of predetermined data to the device 16, so as to enable the device to trigger discounts when subsequently used in transaction units, or to render the device ineffective. The latter purpose could also be achieved by the transaction unit 6 erasing data stored in the device 16. There may also be an operation for loading the stored credit value onto a new data-carrying device, with a new identifier, when an existing device is disabled.

The unit server 8 is also operable (if desired in response to a confirmation message from the transaction unit 6 that the desired operation has been performed) to clear the activity flag associated with the card identifier, and transmit to the other units 6 an indication that the flag has been cleared so that the identifier can be deleted from the lists stored thereby.

At the end of the transaction, the unit server 8 receives data representing the credit amount now stored on the data-carrying device, this then being stored by the unit server in place of the previously-stored value.

At least some of the data stored on the web server 30 can be accessed by an account holder via the internet 32. In order to access this data the account holder would normally have to insert into his terminal 34 data representing his account number and a password. The account holder can then readily view a list of the last predetermined number (e.g. 10) of purchases, the amount currently stored on his device 16, etc.

In a particularly preferred embodiment of the invention, the stored revaluation data in the unit server 8, data centre 20 and web server 30 can include, instead of a simple revaluation amount, data representing a period over which the revaluation amount is to be transferred to the data-carrying device 16. The specific manner in which this can be achieved can be chosen in many ways. For example there may be stored (i) a total revaluation amount, (ii) the number of stages over which the amount is to be transferred to the device 16, and (iii) the overall minimum period throughout which the transfer is to occur. In any event, the overall effect is to cause the credit value to be stored by the device 16 to be increased in several successive stages, rather than in a single stage, with the amounts and/or interval between stages being controlled in accordance with the stored revaluation data. An increase in credit value takes place whenever the data-carrying device 16 is inserted into any of the transaction units 6, so long as the rate of transfer does not exceed a permitted maximum This places a limit to the rate at which the stored credit amount can be spent.

In the embodiment described above, it is possible for data, e.g. representing a desired operation, to be generated at several points (e.g. the unit server 8, the data centre 20, etc.). Also, there could be at any given time, several instructions to perform corresponding operations (e.g. revaluations) in respect of the same smart card. Accordingly, it is preferred that each instruction relating to a smart card be provided with a unique transaction identifier, this identifier being generated at the location representing the source of the instruction. The information exchange between the unit server 8, the data centre 20 and the web server 30 would involve also the transfer of the transaction identifiers, so as to ensure that no instruction is overwritten or duplicated.

The information exchange can be protected by conventional cryptographic techniques.

The described embodiment can be varied in many ways. The functions performed by the unit server 8 and the data centre 20 could be combined. Alternatively, the web server 30 and data centre 20 could be combined. Indeed, they could both be omitted, though in this case the unit server 8 is preferably capable of communicating directly with the internet 32. This would allow access to the stored information by the cardholder, and also the transmission of instructions, such as revaluation amounts, to the unit server 8, possibly using electronic mail.

In the arrangement described above, the unit server 8 sends to the transaction units 6 identifiers representing data-carrying devices for which specific operations are to be carried out, but data describing the operation itself is transmitted only to a transaction unit which has read the relevant device. This reduces the amount of data traffic on the LAN 4, while still permitting rapid recognition of particular data-carrying devices which require operations to be carried out. Alternative possibilities include:

(1) arranging for the server to transmit not just device identifiers but also data representing the operations to be performed, this information being sent to each transaction unit so that the transaction unit can perform the operation without requiring additional information from the unit server 8. When the transaction unit 6 provides the unit server 8 with an acknowledgement that the operation has been carried out, the unit server 8 will send cancelling instructions to the other transaction units 6.

(2) The initial transfer of information to all the transaction units 6 can be avoided by arranging for each transaction unit to transmit to the unit server 8 the identifier of each device read by the unit, so that this identifier can be checked against the data stored by the unit server. The unit server will then respond with a message indicating whether an operation needs to be carried out or not, and if so the details of the operation.

The system could combine several of these procedures. For example, the unit server could send a separate “blacklist” identifying cards to be disabled, so that this operation could be performed autonomously, e.g. by the card reader 12 as well as a generic “activity” list for which additional operational data defining the operation to be performed must be requested separately.

The transaction system 2 described above is particularly suitable for closed site environments, but nevertheless allows external transfer of funds into the system from outside the environment, for example using the internet. This arrangement allows enhanced flexibility, especially if the system additionally allows credit to be removed from a data-carrying device and transferred to a specified account, preferably via the internet. In this way, a visitor or temporary employee at the site can be provided with a data-carrying device and easily arrange for transfer of funds to the device to enable its use. When the use of the device is no longer required, the account can be cancelled and the device disabled. The user then can recover any remaining credit on the card (which would be stored in the unit server 8, the data centre 20 and the web server 30), by accessing the transaction system via the internet 32 and issuing appropriate instructions so that the funds are transferred to a specified personal account.

It is envisaged that the identifier stored by each data-carrying device will include a part which is associated with the particular unit server 8 with which the device may be used, together with a further part which identifies a particular account. Transaction units 6 are arranged so that no operations are permitted unless the first part identifies the unit server 8 to which they are connected.

1. A transaction system comprising a network which includes:
(a) a plurality of transaction devices each operable to communicate with a plurality of portable data-carrying devices carrying respective identifiers and each being operable to perform a transaction in response to an authorisation involving a communication with a data-carrying device; and
(b) server means for storing data representing a list of identifiers and operation data associated with each of the identifiers in the list; the system being arranged such that a transaction unit is automatically operable, in response to communicating with a data-carrying device carrying an identifier corresponding to an identifier stored by the database, to perform an operation defined by the operation data associated with that identifier.

2. A transaction system as claimed in claim 1, where the database is capable of storing operation data representing a revaluation amount, and the transaction unit is operable to increase a credit value stored by the data-carrying device by an amount dependent upon said revaluation amount.

3. A transaction system as claimed in claim 1 or claim 2, wherein the database is operable to store operation data representing a cancellation instruction, and where the transaction device is operable in response to that operation data to alter data stored by the data-carrying device to render it inoperable for future use with said transaction units.

4. A transaction system as claimed in any preceding claim, wherein each transaction unit comprises alert means for providing an audio or visual indication to a cardholder, and wherein each transaction unit is selectively operable in response to said operation data to activate said alert means.

5. A transaction system as claimed in any preceding claim, including means for adding identifiers and operation data to said database in response to remotely-provided instructions.

6. A transaction system as claimed in claim 5, including means connected to a wide area network for receiving the instructions.

7. A transaction system as claimed in claim 6, wherein said receiving means is connected to the internet.

8. A transaction system as claimed in any preceding claim, wherein said server means is operable to transmit identifiers stored thereby to each transaction unit, the transaction units each comparing identifiers carried by data-carrying devices read thereby with the identifiers received from the server means.

9. A transaction system as claimed in claim 8, wherein each transaction unit is operable, upon finding a match between an identifier of a data-carrying device read by the unit and an identifier received from the server means, to send a message requesting operation data from the server means.

10. A transaction system as claimed in claim 8 or claim 9, wherein each transaction unit is operable, upon performing an operation defined by said operation data, to send an acknowledgement to the server means, the server means then being operable to transmit cancelling messages to each of the other transaction units so that the identifier is no longer considered in the comparing operation.

11. A transaction system comprising a network including
(a) a plurality of transaction units each operable to communicate with a portable data-carrying device, the devices storing respective identifiers and credit values;
(b) server means storing a database comprising, for each of a plurality of identifiers, (i) a credit value and (ii) revaluation data;
(c) means for receiving instructions and for altering said revaluation data in accordance with the instructions; and
(d) means responsive to the reading, by a transaction unit, of an identifier stored by a data-carrying device for (i) increasing the credit value stored by the data-carrying device by an amount dependent upon said revaluation data and (ii) altering the credit value stored in the database to match that stored by the data-carrying device, thereby taking into account any discrepancies between the credit value formerly stored in the database compared with the credit amount previously stored by the data-carrying device, and the increase of the credit value dependent upon the revaluation data.

12. A transaction system as claimed in claim 11, the transaction system including a further transaction unit which is not connected to the server means but which is operable to alter the credit amount stored by a data-carrying device.

13. A transaction system comprising at least one transaction unit operable to communicate with a portable data-carrying device carrying an identifier and a credit value, the transaction system storing revaluation data, and the transaction unit being operable to increase the credit data stored by the data-carrying device in a progressive manner at a plurality of stages requiring successive communications with the data-carrying device, the maximum rate at which the credit value is increased being determined by the revaluation data.
